(19) United States
(12) Patent Application Publication
(10) Pub. No.: US 2014/0208598 A1
(43) Pub. Date: Jul. 31, 2014

(54) VEGETATION CUTTER

(71) Applicant: MAKITA CORPORATION, Aichi (JP)

(72) Inventors: Yoshifumi MORITA, Aichi (JP); Akihiro NOMURA, Aichi (JP); Hiroshi NOJIRI, Aichi (JP)

(21) Appl. No.: 14/168,123

(22) Filed: Jan. 30, 2014

(30) Foreign Application Priority Data
Jan. 31, 2013 (JP) 2013-017432

(51) Int. Cl. A01G 3/053

(52) U.S. Cl. CPC A01G 3/053
USPC 30/276

(57) ABSTRACT

A vegetation cutter comprises a frame rod having a front end portion and a rear end portion, and assuming a hollow tube having an open front end; a cutter head mounted on the front end portion of the frame rod and including a drive motor, a cooling fan to be rotated by the drive motor, and a rotary cutter to be rotated by the drive motor; and a power head mounted on the rear end portion of the frame rod and providing electric power for the drive motor. The frame rod is provided with an air intake aperture located at a position rearward than the cutter head and communicating through the hollow tube toward the cutter head. The frame rod is comprised of a front part rod and a rear part rod separably coupled together by means of a tubular joint. The air intake aperture is located on the front part rod.

### FIELD OF THE INVENTION

The present invention relates to a vegetation cutter such as a grass cutter, a lawn trimmer and a brush cutter, and more particularly to a vegetation cutter which comprises a frame rod and a cutter head mounted on the front end of the frame rod and including a motor housing which encloses a drive motor with a cooling fan and rotatably supports a rotary cutter below the motor housing, in which the frame rod is provided with an air intake aperture communicating through the frame rod to the motor housing.

### BACKGROUND OF THE INVENTION

An example of a battery powered tool serving as a vegetation cutter is disclosed in U.S. Pat. No. 5,809,653, which comprises a frame rod (shaft, boom) in the shape of a hollow tube having an open front end, a cutter head (motor housing) mounted on the front end portion of the frame rod, and a power head (battery housing) mounted on the rear end of the frame rod. The cutter head of this vegetation cutter comprises a motor housing fixed to the front end of the frame rod, an electric motor enclosed within the motor housing and a rotary cutter driven by the motor and supported by the motor housing. The power head of this vegetation cutter comprises a battery housing fixed to the rear end portion of the frame rod and a battery attached to the battery housing. With this vegetation cutter, when the motor is energized by the electric supply from the battery, the rotary cutter is rotated by the motor to cut grasses or lawns.

In the vegetation cutter disclosed in the above mentioned US patent, the frame rod is comprised of a front part rod mounted with the cutter head at its front end and a rear part rod mounted with the power head at its rear end, wherein the front part rod and the rear part rod are separably coupled together at the respective coupling ends for convenience of carrying the vegetation cutter and of storing the vegetation cutter in a short space. The coupling ends of the front part rod and the rear part rod are provided with electric connecters for establishing electrical connection between the battery and the motor via electric cables.

With the vegetation cutter of such a type, it would be preferable to introduce air into the motor housing to cool the electric motor enclosed therein. However, if the motor housing is provided with an intake aperture for air, the water which may be attached on the grass may be taken in through the intake aperture inside the motor housing, and further the grass pieces cut by the rotary cutter may clog the intake aperture during the use to obstruct the intake of air. This kind of inconveniences may be avoided, if an air intake aperture is arranged on the power housing which is mounted on the rear end of the frame rod so that the air taken in through the intake aperture into the rear housing will flow through the hollow tube of the frame rod toward the motor housing. However, where the coupling ends of the front part rod and the rear part rod are provided with electric connectors, the connectors may impede the air flow through the hollow tube of the frame rod.

### SUMMARY OF THE INVENTION

In view of the foregoing circumstances, therefore, it is a primary object of the present invention to provide a vegetation cutter, in which the motor housing is not provided with an air intake aperture, but air can be taken inside the motor housing to cool the drive motor therein.

According to the present invention, the object is accomplished by providing a vegetation cutter comprising: a frame rod having a front end portion and a rear end portion, and assuming a hollow tube having an open front end; and a cutter head including a motor housing mounted on the front end portion of the frame rod, a drive motor enclosed within the motor housing, a cooling fan enclosed within the motor housing to be rotated by the drive motor, and a rotary cutter rotatably supported by the motor housing to be rotated by the drive motor, wherein the frame rod is provided with an air intake aperture locating at a position rearward than the motor housing and communicating through the hollow tube toward the motor housing.

In an aspect of the present invention, the frame rod may preferably be comprised of a front part rod having a first coupling end portion and the front end portion on which the motor housing is mounted, and a rear part rod having a second coupling end portion and the rear end portion on which a power head is mounted for providing an electric power for the drive motor, the first coupling end portion and the second coupling end portion being adapted to be coupled to each other, and the first coupling end portion and the second coupling end portion may each preferably be provided with an electric connector for supplying the electric power from the power head to the drive motor in the cutter head, and the air intake aperture may preferably be located on the front part rod.

In a further aspect of the present invention, the frame rod may preferably be provided with a tubular joint for telescopically receiving the first coupling end portion of the front part rod and the second coupling end portion of the rear part rod, and the tubular joint may preferably have a slit extending in an axial direction at a position of the tubular joint where the first coupling end portion of the front part rod is received with the air intake aperture confronting the slit in alignment.

With the vegetation cutter configured as above, in which the frame rod is provided with an air intake aperture locating at a position rearward than the motor housing and communicating through the hollow tube toward the motor housing, the water which may be attached on the grass will not be taken in through the air intake aperture inside the motor housing, and the grass pieces cut by the rotary cutter will not clog the air intake aperture during the use to obstruct the intake of air.

Further, with the vegetation cutter where the frame rod is comprised of a front part rod and a rear part rod to be separably coupled together, the vegetation cutter will be convenient for carrying and for storing in a short space. Further, as the air intake aperture is located on the front part rod, the air taken in through the intake aperture will flow through the inside tube of the front part rod toward the motor in the cutter head, although the coupling ends of the front part rod and the rear part rod are provided with the connectors for supplying electric power from the power head to the cutter head.

Where the frame rod is provided with a tubular joint for telescopically receiving the coupling end portion of the front part rod and the coupling end portion of the rear part rod, and the tubular joint has a slit extending in an axial direction at a position where the coupling end portion of the front part rod is received, with the air intake aperture confronting the slit in alignment, the air intake aperture on the front part rod will be camouflaged by the tubular joint so that the aesthetic feature of the appearance of the vegetation cutter will not be deteriorated.

### BRIEF DESCRIPTION OF THE DRAWINGS

For a better understanding of the present invention, and to show how the same may be practiced and will work, reference will now be made, by way of example, to the accompanying drawings, in which:

FIG. 1a is an overall perspective view of an embodiment of a vegetation cutter according to the present invention;

FIG. 1b is an enlarged perspective view of the cutter head of the embodiment as encircled in FIG. 1a;

FIG. 2a is a partial perspective view of the coupling ends of the front part rod and the rear part rod of the frame rod in their coupled condition;

FIG. 2b is a partial perspective view of the coupling ends of the front part rod and the rear part rod of the frame rod in their decoupled condition;

FIG. 3a is a partial perspective view in cross section of the part shown in FIG. 2a as sectioned by the vertical plane along the longitudinal axis of the frame rod in their coupled condition;

FIG. 3b is a partial perspective view in cross section of the part shown in FIG. 2b as sectioned by the vertical plane along the longitudinal axis of the frame rod in their decoupled condition;

FIG. 4 is a bottom view of the part shown in FIG. 2a in the coupled condition;

FIG. 5 is a side elevational view in cross section of the cutter head shown in FIG. 1b as sectioned by the vertical plane;

FIG. 6a is a perspective view of an example of a protector cap for covering the coupling end portion of the front part rod; and

FIG. 6b is a perspective view of another example of a protector cap for covering the coupling end portion of the front part rod.

### DETAILED DESCRIPTION OF EMBODIMENTS OF THE INVENTION

The invention and its embodiments can now be better understood by turning to the following detailed description of the preferred embodiments with reference to the accompanying drawings. The embodiments of the vegetation cutter hereunder described are of an electric motor-driven type.

It should be expressly understood that the illustrated embodiments are presented just as practicable examples of the invention and that the invention as defined by the claims may be broader than the illustrated embodiments described below. In the drawing, like reference characters refer to like parts so that repetitive explanations may be omitted.

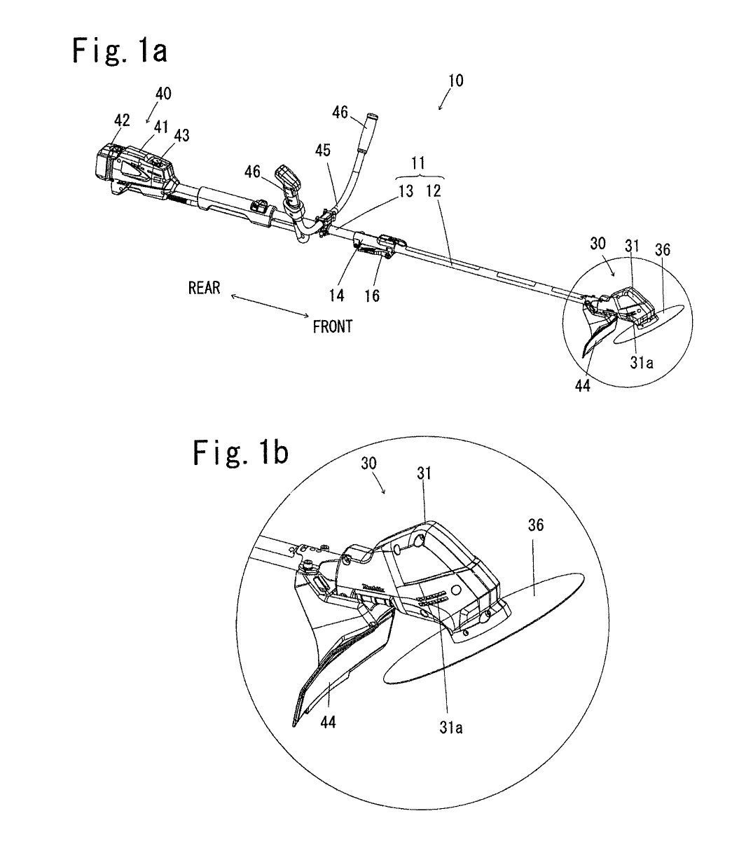

FIG. 1a illustrates an overall view of an embodiment of a vegetation cutter according to the present invention, in which the vegetation cutter 10 comprises a frame rod 11 of a hollow cylindrical tube extending longitudinally from front to rear, a cutter head 30 mounted on the front end portion of the frame rod 11, and a power head 40 mounted on the rear end portion of the frame rod 11.

As shown in FIG. 1a, the frame rod 11 is comprised of a front part rod 12 and a rear part rod 13, which are coupled together by means of a tubular joint 14. The front part rod 12 and the rear part rod 13 are hollow cylindrical tube members each with an open front end and an open rear end. On the front end portion of the front part rod 12 is mounted the cutter head 30, while on the rear end portion of the rear part rod 13 is mounted the power head 40.

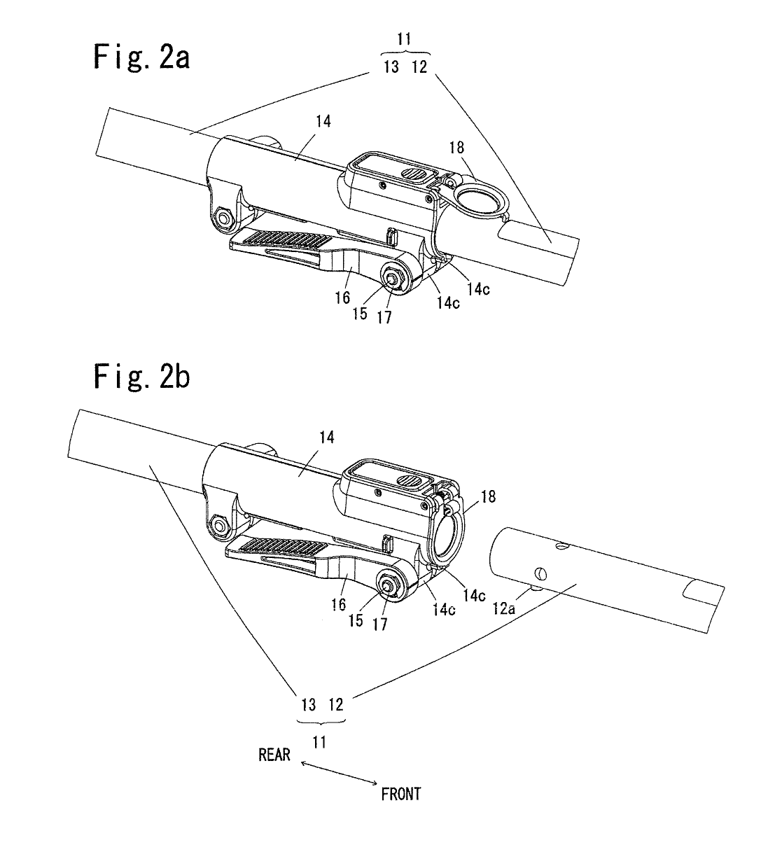

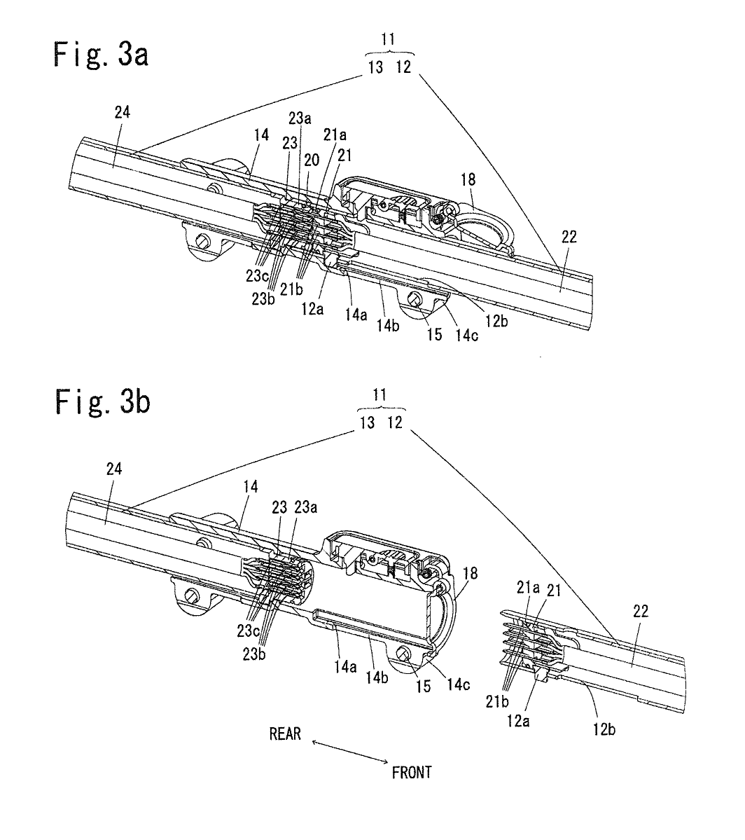

FIGS. 2a, 2b, 3a and 3b illustrate the configuration of the tubular joint 14 in detail, in which FIGS. 2a and 2b show external structures of the tubular joint 14 with the front part rod 12 and the rear part rod 13 in a coupled condition and in a decoupled condition, respectively, and FIGS. 3a and 3b show internal structures of the tubular joint 14 with the front part rod 12 and the rear part rod 13 in a coupled condition and in a decoupled condition, respectively. As seen from the Figures, the tubular joint 14 is made of a cylindrical member for coupling the front part rod 12 and the rear part rod 13. The rear half part of the tubular joint 14 coaxially receives the front end portion (termed a “second coupling end portion” in the claims) of the rear part rod 13 and is fixed thereto by means of a screw. The front half part of the tubular joint 14 detachably receives the rear end portion (termed a “first coupling end portion” in the claims) of the front part rod 12 and clamps the same by means of a lever-tightened screw.

The inner bottom wall of the front part of the tubular joint 14 is formed with a positioning groove 14a extending in the longitudinal direction of the tube, while the outer bottom surface of the rear end portion of the front part rod 12 is formed with a positioning stub 12a, so that the positioning stub 12a engages with the positioning groove 14a to determine the circumferential position of the front part rod 12 relative to the tubular joint 14. The outer bottom wall of the tubular joint 14 is formed with a longitudinal slit 14b under the positioning groove 14a. Bosses 14c, 14c are formed integrally with the lower outer walls of the tubular joint 14 on the both sides of the slit 14b at the front end thereof. A bolt 15 extends through the bosses 14c, 14c for fixing the tubular joint 14 on the front part rod 12. A nut 17 to be rotated with the lever 16 engages with the bolt 15. When the lever 16 is pulled up to narrow the width of the slit 14b, the tubular joint 14 is clamped to the front part rod 12. When the lever 16 is pushed down to widen the width of the slit 14b, the tubular joint 14 is loosened from the front part rod 12 to make the front part rod 12 detachable from the tubular joint 14, i.e. from the rear part rod 13. The open front end of the tubular joint 14 is provided with an openable lid 18 to cover the same.

The coupling end portions of the front part rod 12 and the rear part rod 13 are provided with connectors 20 as shown in FIGS. 3a and 3b for electrically connecting the drive motor 32 in the cutter head 30 and the battery pack (electric power source) 42 detachably attached to the power head 40. Inside the rear end portion of the front part rod 12 is arranged a plug 21 constituting the connector 20, while inside the front end portion of the rear part rod 13 is arranged a socket 23 constituting the connector 20.

The plug 21 includes a holder piece 21a in the shape of a cylinder which is tightly fitted to the inner wall of the rear end portion of the front part rod 12 by means of an O-ring. The holder piece 21a holds a number of plug pins 21b penetrating therethrough, to which plug pins 21b is connected an electric cable 22 from the drive motor 32.

The socket 23 includes at the front end of the rear part rod 13 a holder piece 23a in the shape of a cylinder which is tightly fitted in the tubular joint 14, with the front end of the socket 23a detachably inserted into the rear end portion of the front part rod 12. The holder piece 23a is tightly fitted to the inner wall of the front end portion of the rear part rod 13 by means of an O-ring. The holder piece 23a is formed with a number of socket holes 23b each for holding a socket contact 23c connected to an electric cable 24 from the battery pack 42, wherein each of the socket contacts 23c of the socket 23 receives each of the plug pins 21b of the plug 21.

Where the rear end portion of the front part rod 12 is inserted through the front half part of the tubular joint 14 to couple the front part rod 12 and the rear part rod 13 as shown in FIG. 3a, the front part of the socket 23 is inserted through the rear end portion of the front part rod 12 so that the plug pins 21b of the plug 21 are inserted into the socket holes 23b to touch the socket contacts 23c, whereby the drive motor 32 is electrically connected to the battery pack 42. On the other hand, where the front part rod 12 is pulled out from the tubular joint 14 to separate the front part rod 12 from the rear part rod 13 as shown in FIG. 3b, the front part of the socket 23 disengages from the rear end portion of the front part rod 12 so that the plug pins 21b of the plug 21 are pulled off from the socket holes 23b to separate from the socket contacts 23c, whereby the drive motor 32 is electrically disconnected from the battery pack 42.

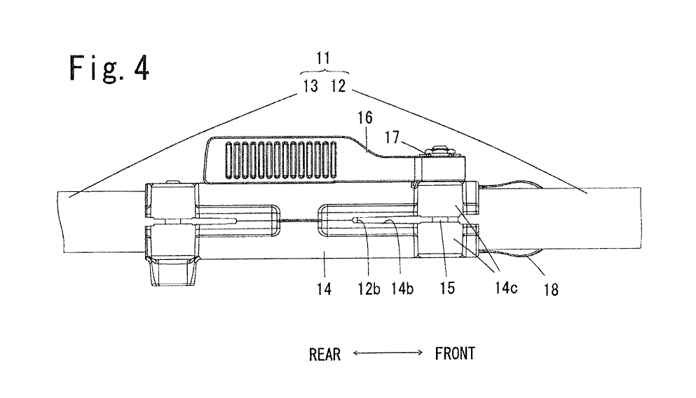

As shown in FIGS. 3a, 3b and 4, the bottom wall of the rear end portion of the front part rod 12 is formed with an air intake aperture 12b at a position frontward than the plug 21. The air intake aperture 12b is to introduce air from the front part rod 12 of the frame tube 11 into the motor housing 31. The air intake aperture 12b of the front part rod 12 is formed at the position to confront the slit 14b of the tubular joint 14 in alignment so that the air intake aperture 12b of the front part rod 12 can freely introduce air from the atmosphere without being closed by the tube wall.

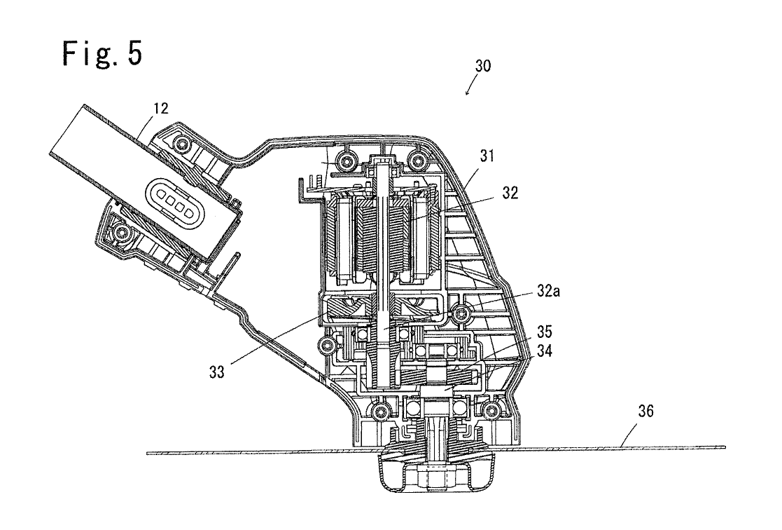

FIG. 5 shows the cutter head 30 in cross-section, in which the cutter head 30 includes the motor housing 31 mounted on the front end portion of the front part rod 12 of the frame rod 11. The motor housing 31 encloses the drive motor 32, which has a motor output shaft 32a, to which in turn is fixed a cooling fan 33. The cooling fan 33 is to suck air from the air intake aperture 12b through the frame rod 11 into the motor housing 31 and to flow the air around the drive motor 32, and finally to exhaust the same through a venthole 31a (shown in FIGS. 1a and 1b) formed on the motor housing 31 near the circumference of the cooling fan 33. To the motor output shaft 32a of the drive motor 32 is engaged a reduction gear 35 integrally fixed to a cutter shaft 34. The lower end portion of the cutter shaft 34 extends downward below the motor housing 31, at the tip of which shaft 34 is detachably fixed a rotary cutter 36. It should be understood that the hollow bore of the frame rod 11 has the maximum open area or the unique opening in the suction side path for the cooling fan 33 in the motor housing 31.

The power head 40 is mainly comprised of a controller housing 41 and a control circuit (not shown). The controller housing 41 is mounted on the rear end portion of the rear part rod 13 of the frame rod 11. To the rear part of the controller housing 41 is detachably coupled a battery pack 42. The battery pack 42 is electrically connected the drive motor 32 in the cutter head 30 by means of the electric cables 22, 24 and the connector 20 (21 and 23) arranged within the frame rod 11. The controller housing 41 has, on its upper face in the front part, a control knob 43 for adjusting the rotation speed of the drive motor 32 of the cutter head 30.

To the frame rod 11 is also mounted a cutter guard 44 near the cutter head 30 to cover the rear side of the rotary cutter 36. A handle 45 is fixed to the frame rod 11 on the middle part thereof. The handle 45 extends transversely to the longitudinal axis of the frame rod 11, and is curved upward both in its right and left end portions. Near the both ends of the handle 45 are fixed grips 46, 46 for the user to hold the handle 45.

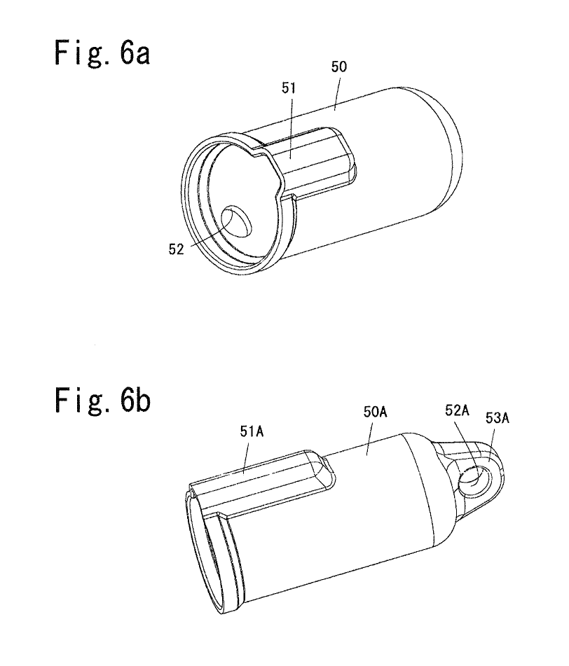

A protector cap 50 as depicted in FIG. 6a may be prepared to detachably cover the rear end portion of the front part rod 12 of the frame rod 11 in order to protect the plug 21 arranged at the rear end of the front part rod 12 from possible damages by dusts or crashes. The protector cap 50 is made of rubber in the shape of a cup, i.e. a cylinder having a bottom as shown in FIG. 6a and can be put on the rod end firmly sticking to the outer wall surface there. A part of the circumference of the cylindrical wall is provided with an outward protrusion (or swelling) 51 extending longitudinally from the open end of the cup to the middle point in the longitudinal direction for accommodating the positioning stub 12a in the rear end portion of the front part rod 12. The circumference of the cylindrical wall is provided with a circular hole 52 at the position radially opposite to the outward protrusion 51 for hanging the protector cap 50 on a hook (not shown) disposed on the handle 45 when the protector cap 50 is out of use, i.e. when the front part rod 12 and the rear part rod 13 are coupled together.

Depicted in FIG. 6b is another type of protector cap 50A, which is made of rubber in the shape of a cup as the protector cap 50 of FIG. 6a, and can be put on the rod end firmly sticking to the outer wall surface there. This embodiment is also provided with an outward protrusion 51A extending longitudinally from the open end of the cup to the middle point in the longitudinal direction in a part of the circumference of the cylindrical wall. The protector cap 50A is further provided with a tab 53A integrally with the bottom wall of the cylinder axially opposite to the open end of the cylinder. The tab 53A is to be pinched by the fingers when the protector cap 50A is to be pulled off from the front part rod 12. The tab 53A is provided with a hole 52A for hanging the protector cap 50A on a hook (not shown) disposed on the handle 45 as mentioned above. The hole 52A may preferably have a diameter large enough for a finger to go through, which will be convenient for pulling off the protector cap 50A from the front part rod 12.

In the vegetation cutter 10 as described above, as the drive motor 32 in the cutter head 30 is energized by the electrical supply from the battery pack 42, the motor output shaft 32a rotates the cutter shaft 34 via the engaging reduction gear 35, which in turn rotates the rotary cutter 36 fixed to the cutter shaft 34. The user operates the vegetation cutter 10 by grasping the grips 46, 46 of the handle 45 with the both hands, swings the frame rod 11 to sweep the grassy ground by the rotating rotary cutter 36 of the cutter head 30, whereby the grasses are cut off by the rotating rotary cutter 36. Further, as the drive motor 32 rotates the cooling fan 33, air will be sucked in through the air intake aperture 12b formed on the rear end portion of the front part rod 12 into the inner bore of the front part rod 12, and will flow into the motor housing 31 and around the drive motor 32, and will be exhausted from the venthole 31a into the atmosphere.

As the vegetation cutter 10 according to the present invention is provided with an air intake aperture 12b on the front part rod 12 of the frame rod 11 at the rear end portion of the front part rod 12 which is the position rearward than the motor housing, and not on the motor housing itself, for introducing air into the motor housing 31, air will be sucked in at the position above and apart from the grassy ground surface. Thus the air intake aperture 12b is maintained above and away from the ground surface with growing grass while the vegetation cutter is being used, so that the water which may be attached on the grass will not be taken into the motor housing and further the grass pieces cut by the rotary cutter will not clog the air intake aperture, unlike the case where the air intake aperture is located on the cutter housing 31 itself so that water may be taken in and grass pieces may clog the air intake aperture. While in the above embodiment the air intake aperture 12b is positioned on the rear end portion of the front part rod 12, the present invention is not be limited to such a structure, but may be modified to form the air intake aperture 12b at a position in the middle of the length of the front part rod 12 to enjoy the same merit.

In addition, the vegetation cutter 10 of the above described embodiment in which the frame rod 11 is made separable into the front part rod 12 mounted with the cutter head 30 on the front end portion thereof and the rear part rod 13 adapted to be coupled to the rear end portion of the front part rod 12 will be convenient for carrying and for storing. In the described embodiment, the rear part rod 13 is mounted with the controller housing 41 of the power head 40, to which controller housing 41 is attached the battery pack 42 for supplying electric power to the drive motor 32. The coupling end portions of the front part rod 12 and the rear part rod 13 are provided with the electric connector 20 (21 and 23) for electrically connecting the battery pack 42 and the drive motor 32. The connector 20 is comprised of the plug 21 including the holder piece 21a which is tightly fitted to the inner wall of the rear end portion of the front part rod 12 and the socket 23 including the holder piece 23a which is tightly fitted to the inner wall of the front end portion of the rear part rod 13 so that the coupling end portions are closed with the connector 20, which would prevent air from flowing from the rear part rod 13 to the front part rod 12 and an air intake aperture if provided on the rear part rod would not work. With the vegetation cutter according to the present invention which comprises the air intake aperture 12b on the front part rod 12, i.e. at the position forward than (ahead of) the connector plug 21, air can be introduced into the motor housing 31 without being impeded by the connector 20.

In the above described embodiment, the frame rod 11 is provided with a tubular joint 14 for coupling the front part rod 12 and the rear part rod 13 by inserting the rear end portion of the front part rod 12 and the front end portion of the rear part rod 13 into the tubular joint 14. The tubular joint 14 is formed with the longitudinal slit 14b along the bottom wall of the tubular joint 14 around the area where the front part rod 12 is inserted, with the air intake aperture 12b confronting the slit 14b of the tubular joint 14 in alignment. The air intake aperture 12 on the front part rod 12 is thereby camouflaged by the slit 14b of the tubular joint 14, which will improve the aesthetic appearance of the vegetation cutter.

Further in the above described embodiment, the protector cap 50 (50A) is prepared in the shape of a cylinder having a bottom to be detachably applied on the rear end of the front part rod 12. The protector cap 50 (50A) is provided with the circular hole 52 (52A) for hanging on a hook to prevent from missing while the front part rod 12 and the rear part rod 13 are coupled together and the protector cap 50 (50A) is not in use. While, in the above described embodiment, the protector cap 50 (50A) is to be detachably applied on the rear end of the front part rod 12, as the tubular joint 14 is fixed to the front end portion of the rear part rod 13 so that the rear end portion of the front part rod 12 is detachably inserted in the tubular joint 14, the tubular joint 14 may be fixed to the rear end portion of the front part rod 12 so that the front end portion of the rear part rod 13 be detachably inserted in the tubular joint 14, and the protector cap 50 (50A) may be designed to detachably applied on the front end of the rear part rod 13, realizing the same dust preventing function.

Although the above description has been made about the vegetation cutter 10 in which the frame rod 11 is comprised of the front part rod 12 and the rear part rod 13 to be coupled together when in use, the invention is not limited to such a type, but also is applicable to the type in which the frame rod 11 is not separable, enjoying the same merit. Further, the frame rod 11 may be comprised of a front part rod 12, a rear part rod 13 and one or more middle part rods to be coupled together, enjoying the same merit.

While, in the illustrated embodiment, the plug 21 of the connector 20 is arranged at the rear end of the front part rod 12 and the socket 23 is arranged at the front end of the rear part rod 13, the plug may be arranged at the front end of the rear part rod 13 and the socket may be arranged at the rear end of the front part rod 12, instead.

Further, while the above-described vegetation cutter 10 comprises the air intake aperture in the shape of an elongate slit formed on the front part rod 12, the shape of the air intake aperture 12b is not necessarily limited to an elongate slit, but may be of another shape such as a circle, an ellipse, a corner-rounded rectangle, and so forth.

What is claimed is:

1. A vegetation cutter comprising:
a frame rod having a front end portion and a rear end portion, and assuming a hollow tube having an open front end; and
a cutter head including a motor housing mounted on the front end portion of the frame rod with the open front end of the frame rod opening into the motor housing, a drive motor enclosed within the motor housing, a cooling fan enclosed within the motor housing to be rotated by the drive motor, and a rotary cutter rotatably supported by and below the motor housing to be rotated by the drive motor,
wherein the frame rod is provided with an air intake aperture located at a position rearward than the motor housing and communicating through the hollow tube toward the motor housing.

2. A vegetation cutter as claimed in claim 1, wherein the frame rod is comprised of a front part rod having a first coupling end portion and the front end portion on which the motor housing is mounted, and a rear part rod having a second coupling end portion and the rear end portion on which a power head is mounted for providing an electric power for the drive motor, the first coupling end portion and the second coupling end portion being adapted to be coupled to each other,
wherein the first coupling end portion and the second coupling end portion are each provided with an electric connector for supplying the electric power from the power head to the drive motor in the cutter head, and
wherein the air intake aperture is located on the front part rod.

3. A vegetation cutter as claimed in claim 2, wherein the frame rod is provided with a tubular joint for coaxially receiving the first coupling end portion of the front part rod and the second coupling end portion of the rear part rod, and
wherein the tubular joint has a slit extending in an axial direction at a position where the first coupling end portion of the front part rod is received, with the air intake aperture confronting the slit.
